(19) United States
(12) Patent Application Publication
(10) Pub. No.: US 2012/0034426 A1
(43) Pub. Date: Feb. 9, 2012

(54) ARTICLE AND METHOD FOR BONDING SUBSTRATES WITH LARGE TOPOGRAPHIES

(75) Inventors: Richard J. Webb, Inver Grove Heights, MN (US); Wayne S. Mahoney, St. Paul, MN (US); Eric G. Larson, Lake Elmo, MN (US)

(73) Assignee: 3M Innovative Properties Company

(21) Appl. No.: 12/850,772

(22) Filed: Aug. 5, 2010

(51) Int. Cl. B32B 3/30; B32B 38/00; B32B 37/02

(52) U.S. Cl. 428/172; 156/307.3; 156/60; 156/307.5

(57) ABSTRACT

The present invention is an article useful in the field of wafer processing, for example. The article includes a substrate, a leveling layer, a joining layer, a photothermal conversion layer and a temporary carrier. The substrate has a first major surface, a second major surface and at least one three dimensional topographical feature extending from the first major surface and having an initial step height. The leveling layer is positioned adjacent to the first major surface and reduces a topography of the substrate to between about 5% and about 95% of the initial step height. The joining layer is positioned adjacent to the leveling layer and further reduces the topography of the substrate to less than about 20% of the initial step height. The photothermal conversion layer is positioned adjacent to the joining layer and the temporary carrier is positioned adjacent the photothermal conversion layer.

### FIELD

The present invention is related generally to the field of wafer support systems. In particular, the present invention is related to providing a void free bond between a wafer and a temporary carrier of a wafer support system.

### BACKGROUND

Wafer support systems (WSS) are used in the field of wafer planarization to bond wafers, such as silicon wafers, to a rigid temporary carrier in order to grind the back surfaces of the wafers to a desired thickness. One method currently used for temporarily supporting a wafer is the Wafer Support System (WSS) for ultra thin wafer back-grinding developed by 3M Company located in St. Paul, Minn. This technique utilizes a temporary carrier, such as a glass carrier, having a photothermal conversion layer coated on the temporary carrier. The temporary carrier is positioned on the wafer such that, when the temporary carrier and wafer are laminated together, the photothermal conversion layer is positioned between the temporary carrier and the wafer. An ultraviolet (UV) curable joining layer is spin-coated onto the wafer such that the photothermal conversion layer is actually in contact with the joining layer. The photothermal conversion layer and the joining layer thus temporarily bond the wafer to the temporary carrier during grinding operations and subsequent processing steps. After the grinding operations and wafer processing steps are completed, the wafer and joining layer are de-bonded from the temporary carrier by applying radiation energy to the photothermal conversion layer. The application of the radiation energy causes the photothermal conversion layer to decompose, allowing separation of the temporary carrier from the joining layer and the substrate.

After the joining layer is deposited onto the wafer, the space between the wafer and the temporary carrier is evacuated and the temporary carrier is moved into contact with the liquid joining layer. If the topography on the surface of the wafer is small enough, the joining layer can flow and fill in any spaces between features to produce a void free bond. However, if the topography of the surface of the wafer is too large, the joining layer cannot flow enough to fill all the spaces between features and, as a consequence, voids remain after bonding. Voids may also be present if there are large spaces between features on the wafer surface.

A substantially void free bond between the wafer and the temporary carrier is desired because subsequent backprocessing steps are often performed at high temperatures. At high temperatures, the pressure within the voids can increase, causing the wafer to delaminate from the temporary carrier. The ability to bond wafers with large topographies in a void free manner is important because an increasing number of process flows require bonding wafer surfaces that have solder balls, pre-bonded die or other large features already in place.

### SUMMARY

In one embodiment, the present invention is an article useful in the field of wafer processing, for example. The article includes a substrate, a leveling layer, a joining layer, a photothermal conversion layer and a temporary carrier. The substrate has a first major surface, a second major surface and at least one three dimensional topographical feature extending from the first major surface and having an initial step height. The leveling layer is positioned adjacent to the first major surface and reduces a topography of the substrate to between about 5% and about 95% of the initial step height. The joining layer is positioned adjacent to the leveling layer and further reduces the topography of the substrate to less than about 20% of the initial step height. The photothermal conversion layer is positioned adjacent to the joining layer and the temporary carrier is positioned adjacent the photothermal conversion layer.

In a second embodiment, the present invention is a method of manufacturing a laminated article. The method includes providing a substrate having first and second major surfaces, wherein at least the first major surface includes a three dimensional topographical feature covering at least a portion of its surface, the topographical feature having an initial step height; coating a leveling layer on the first major surface to reduce the topography of the substrate; coating a joining layer onto the leveling layer to further reduce the topography of the substrate; providing a temporary carrier; providing a photothermal conversion layer; joining the substrate to the temporary carrier; and drying or curing the photothermal conversion layer, joining layer and leveling layer to form the laminated article. The leveling layer reduces the topography of the substrate to between about 5% and about 95% of the initial step height. The joining layer reduces the topography of the substrate to less than about 20% of the initial step height. The substrate is joined to the temporary carrier by contacting the joining layer to the photothermal conversion layer and the photothermal conversion layer to the temporary carrier.

### BRIEF DESCRIPTION OF THE DRAWINGS

FIG. 1 is a cross-sectional view of a substrate having a large topography.

FIG. 2 is a cross sectional view of an article of the present invention, including the substrate of FIG. 1.

FIG. 3 is a cross-sectional view of a fixture holding the substrate prior to coating.

FIG. 4 is a cross-sectional view of the substrate of the present invention including a leveling layer.

FIG. 5 is a cross-sectional view of the substrate of the present invention including a joining layer.

### DETAILED DESCRIPTION

The article of the present invention results in a substantially void-free bond between a substrate surface having a large topography, such as a wafer surface, and a temporary carrier. Creating a void-free or substantially void-free bond minimizes the likelihood that the substrate will prematurely debond from the temporary carrier, particularly during high temperature processing steps. A method of forming a void-free or substantially void-free bond is also disclosed. The method includes reducing the topography of the substrate surface by applying a leveling coating onto the substrate surface, at least partially drying and/or at least partially curing the leveling coating and bonding the resulting coated substrate to a temporary carrier. Although the article and method of the present invention are discussed in relation to a wafer used in a wafer support system, the article and method may be used on other articles and in other processes without departing from the intended scope of the present invention.

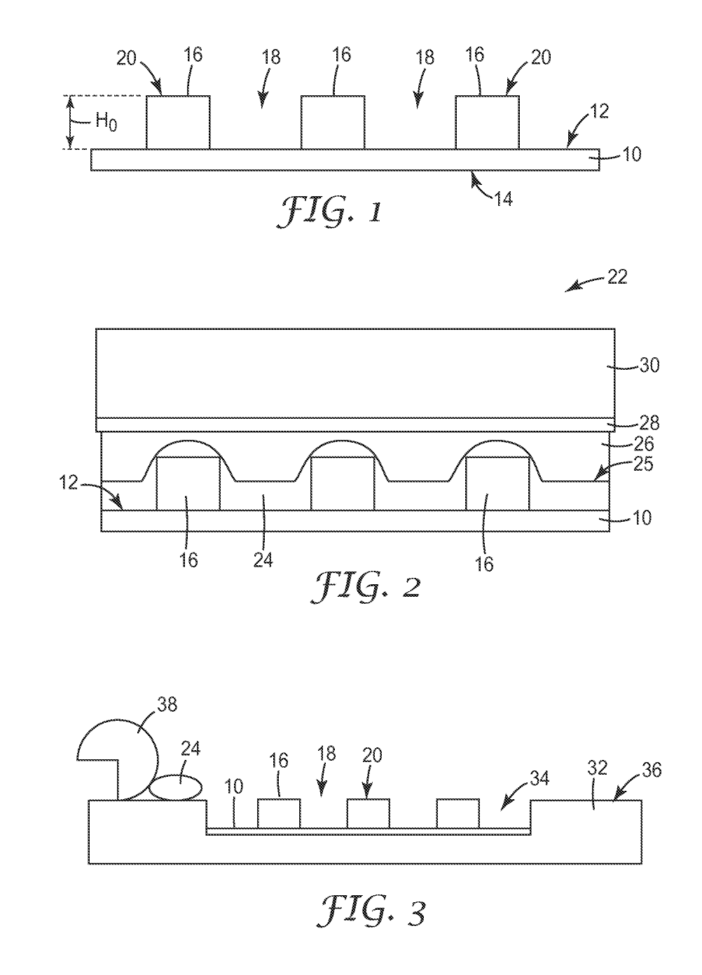

FIG. 1 shows a cross-sectional view of a substrate 10 having a large topography. The substrate 10 includes a first major surface 12, a second major surface 14 and a plurality of three-dimensional topographical features 16 extending from the first major surface 12. The features 16 extend individually from the first major surface 12 of the substrate 10, forming recesses 18 between adjacent features 16. Exemplary features 16 can include, but are not limited to, solder balls and pre-bonded die. The features 16 include an initial step height H₀ measured from the first major surface 12 of the substrate 10 to the top surface 20 of the feature 16. In one embodiment, the features 16 have an initial step height H₀ of between about 50 microns and about 1000 microns, particularly between about 100 microns and about 500 microns and more particularly between about 100 microns and about 300 microns. Although FIG. 1 depicts the substrate 10 as including a plurality of features 16, the substrate 10 may include any number of features 16, including only one, without departing from the intended scope of the present invention. In addition, although the features 16 are depicted as being similar in shape and size and having a rectangular cross-section, the features may take on any form, shape, size, height, etc. without departing from the intended scope of the present invention. Similarly, although each of the features 16 is depicted as being spaced relatively equidistant from adjacent features, the feature placement on the substrate 10 may take on various patterns or non-patterns without departing from the intended scope of the present invention. In all cases, the initial step height H₀ is the maximum step height of all of the features. For example, if a substrate included two features of varying heights, the feature having the greatest height would determine the initial step height H₀.

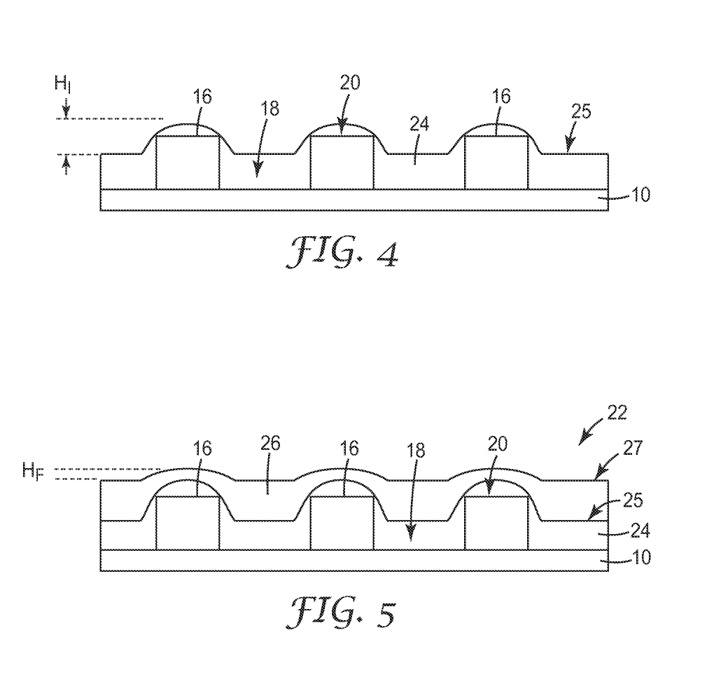

FIG. 2 shows a cross-sectional view of an article 22 formed from the substrate 10 of FIG. 1. The article 22 includes the substrate 10, a leveling layer 24, a joining layer 26, a photothermal conversion layer 28 and a temporary carrier 30. The leveling layer 24 is positioned on the first major surface 12 of the substrate 10 and has an intermediate step height H_{I} (shown in FIG. 4), measured from the highest point of the leveling layer 24 above a feature 16 to the lowest point of the leveling layer 24 in an adjacent recess 18. The leveling layer 24 thus reduces the topography of the substrate 10 to the intermediate step height H_{I} (shown in FIG. 4). The joining layer 26 is positioned on the leveling layer 24 and further reduces the topography of the substrate 10 to a final step height H_{F} (shown in FIG. 5). The final height H_{F} is measured from the highest point of a top surface 27 of the joining layer 26 above a feature 16 to the lowest point of the top surface 27 of the joining layer 26 in an adjacent recess 18. The photothermal conversion layer 28 is positioned on the joining layer 26 and the temporary carrier 30 is positioned on the photothermal conversion layer 28.

The elements forming the article 22 are described in greater detail below.

### Substrate

The substrate 10 may be, for example, a brittle material that may be difficult to thin using conventional methods. Examples thereof include substrates such as silicon, gallium arsenide, sapphire, glass, quartz, gallium nitride and silicon carbide.

### Leveling Layer

The leveling layer 24 functions to reduce the topography on the surface of the substrate 10 in order to allow subsequent spin coating and vacuum bonding processes to fill in the remaining topography and produce a void free bond between the substrate 10 and the temporary carrier 30. The leveling layer 24 can be applied by any number of methods including, but not limited to, knife coating and applying the leveling material at an edge of the substrate 10 and then optionally placing a liner over the leveling material and filling in the recesses 18 (shown in FIG. 1) produced by the features 16 with a roller or notch bar. After the leveling layer 24 is applied onto the surface of the substrate 10, the leveling layer 24 can either be at least partially dried and/or partially cured.

In one embodiment, the leveling layer 24 reduces the topography of the substrate 10, as defined by the initial step height H₀ of the features 16, to an intermediate step height H_{I} that is between about 5% and about 95% of the initial step height H₀. Particularly, the leveling layer 24 reduces the topography of the substrate 10 to an intermediate step height H_{I} that is between about 5% and about 75% of the initial step height H₀ and more particularly, to between about 5% and about 25% of the initial step height H₀. The intermediate step height H_{I} thus produces an intermediate substrate topography defined by the top surface 25 of the leveling layer 24.

Suitable leveling layer materials include, but are not limited to, adhesives. Examples of adhesives which can be used as the leveling layer material include, but are not limited to: rubber-base adhesives obtained by dissolving rubber, elastomer or the like in a solvent, one-part thermosetting adhesives based on epoxy, urethane or the like, two-part thermosetting adhesives based on epoxy, urethane, (meth)acrylate, silicone or the like, hot-melt adhesives, light-curable (ultraviolet (UV) or visible) or electron beam-curable adhesives based on (meth)acrylate, silicone, epoxy or the like, water dispersion-type adhesives and combinations thereof. UV-curable adhesives obtained by adding a photo-polymerization initiator and, if desired, additives to (1) an oligomer having a polymerizable vinyl group, such as urethane acrylate, epoxy acrylate or polyester acrylate, and/or (2) an acrylic or methacrylic monomer are suitably used. Examples of additives include a thickening agent, a plasticizer, a dispersant, a filler, a fire retardant and a heat stabilizing agent.

### Joining Layer

The joining layer 26 is used for fixing the substrate 10 to the temporary carrier 30 through the leveling layer 24 and the photothermal conversion layer 28. To promote strong adhesion between the substrate 10 and the temporary carrier 30, the joining layer 26 creates a substantially planar surface once deposited on the leveling layer 24. In one embodiment, the joining layer 26 reflects light in the near infrared region. The thickness of the joining layer 26 is not particularly limited as long as it can ensure the thickness uniformity required for grinding the substrate 10 and the tear strength necessary for the peeling of the joining layer 26 from the substrate 10 after removing the temporary carrier 30 from the article 22, and can sufficiently absorb asperities on the substrate 10 surface.

In one embodiment, the joining layer 26 reduces the topography of the substrate 10 to a final step height H_{F} of less than about 20% of the initial step height H₀. Particularly, the joining layer 26 reduces the topography of the substrate 10 to a final step height H_{F} of less than about 10% of the initial step height H₀ and more particularly, to less than about 5% of the initial step height H₀. Even more particularly, the joining layer 26 reduces the initial step height H₀ of the substrate 10 to a final step height H_{F} of substantially 0% of the initial step height H₀, or 0%. Thus, after deposition of the joining layer 26, the recesses 18 caused by the features 16 on the substrate 10 will be substantially or completely filled in, creating a substantially planar surface such that the formation of voids is minimized or prevented when the temporary carrier 30 and photothermal conversion layer 28 are positioned on the joining layer 26 (shown in FIG. 5). The final step height H_{F} produces a final topography defined by the top surface 27 of the joining layer 26. In one embodiment, the thickness of the joining layer 26 is typically from about 10 to about 150 microns particularly from about 25 to about 100 microns.

Suitable materials that can be used for the joining layer 26 include, but are not limited to, adhesives. Examples of adhesives which can be used as the joining layer material include, but are not limited to: rubber-base adhesives obtained by dissolving rubber, elastomer or the like in a solvent, one-part thermosetting adhesives based on epoxy, urethane or the like, two-part thermosetting adhesives based on epoxy, urethane, acryl or the like, hot-melt adhesives, light- or electron beam-curable adhesives based on (meth)acrylate, epoxy or the like, and water dispersion-type adhesives. Light-curable adhesives obtained by adding a photopolymerization initiator and, if desired, additives to (1) an oligomer having a polymerizable vinyl group, such as urethane acrylate, epoxy acrylate or polyester acrylate, and/or (2) an acrylic or methacrylic monomer are suitably used. Examples of additives include a thickening agent, a plasticizer, a dispersant, a filler, a fire retardant and a heat stabilizing agent.

### Photothermal Conversion Layer

The photothermal conversion layer 28 is provided between the substrate 10 and the temporary carrier 30. The photothermal conversion layer 28 decomposes upon irradiation with radiation energy such as laser beam, whereby the substrate 10 can be separated from the temporary carrier 30 without causing any breakage. In one embodiment, the photothermal conversion layer 28 contains a light absorbing agent and a heat decomposable resin. Radiation energy applied to the photothermal conversion layer 28 in the form of a laser beam or the like is absorbed by the light absorbing agent and converted into heat energy. The heat energy generated abruptly elevates the temperature of the photothermal conversion layer 28 and the temperature reaches the thermal decomposition temperature of the heat decomposable resin (organic component) in the photothermal conversion layer 28 resulting in heat decomposition of the resin. The gas generated by the heat decomposition is believed to form a void layer (such as air space) in the photothermal conversion layer 28 and divide the photothermal conversion layer 28 into two parts, whereby the substrate 10 and the temporary carrier 30 are separated.

The light absorbing agent absorbs radiation energy at the wavelength used. The radiation energy is usually a laser beam having a wavelength of about 300 to about 11,000 nanometers (nm), particularly about 300 to about 2,000 nm. Specific examples thereof include a YAG laser which emits light at a wavelength of about 1,064 nm, a second harmonic generation YAG laser at a wavelength of about 532 nm, and a semiconductor laser at a wavelength of about 780 to about 1,300 nm. Although the light absorbing agent varies depending on the wavelength of the laser beam, examples of the light absorbing agent which can be used include carbon black, graphite powder, microparticle metal powders such as iron, aluminum, copper, nickel, cobalt, manganese, chromium, zinc and tellurium, metal oxide powders such as black-titanium-oxide and indium-tin-oxide, and dyes and pigments such as an aromatic diamino-based metal complex, an aliphatic diamine-based metal complex, an aromatic dithiol-base metal complex, a mercaptophenol-based metal complex, a squarylium-based compound, a cyanine-based dye, a methine-based dye, a naphthoquinone-based dye and an anthraquinone-based dye. The light absorbing agent may be in the form of a film including a vapor deposited metal film. Among these light absorbing agents, carbon black is particularly useful, because the carbon black significantly decreases the force necessary for separating the substrate 10 from the support substrate 30 after the irradiation and accelerates the separation.

The concentration of the light absorbing agent in the photothermal conversion layer 28 varies depending on the kind, particle state (structure) and dispersion degree of the light absorbing agent but the concentration is usually from about 5 to about 70 vol % in the case of general carbon black having a particle size of approximately from about 5 to about 500 nm. If the concentration is less than about 5 vol %, heat generation of the photothermal conversion layer 28 may be insufficient for the decomposition of the heat decomposable resin, whereas if it exceeds about 70 vol %, the photothermal conversion layer 28 becomes poor in the film-forming property and may readily cause failure of adhesion to other layers. In the case where the adhesive used as the leveling layer 24 and the joining layer 26 is a UV-curable adhesive, if the amount of carbon black is excessively large, the transmittance of the ultraviolet ray for curing the adhesive decreases. Therefore, in the case of using a UV-curable adhesive as the leveling layer 24 and the joining layer 26, the amount of carbon black should be about 60 vol % or less.

Examples of heat decomposable resins which can be used include, but are not limited to: gelatin, cellulose, cellulose ester (e.g., cellulose acetate, nitrocellulose), polyphenol, polyvinyl butyral, polyvinyl acetal, polycarbonate, polyurethane, polyester, polyorthoester, polyacetal, polyvinyl alcohol, polyvinylpyrrolidone, a copolymer of vinylidene chloride and acrylonitrile, poly(meth)acrylate, polyvinyl chloride, silicone resin and a block copolymer comprising a polyurethane unit. These resins can be used individually or in combination of two or more thereof. The glass transition temperature (Tg) of the resin is particularly about room temperature (20° C.) or more so as to prevent the re-adhesion of the photothermal conversion layer 28 once it is separated due to the formation of a void layer as a result of the thermal decomposition of the heat decomposable resin, and the Tg is more particularly about 100° C. or more so as to prevent the re-adhesion. In the case where the light transmitting support is glass, in order to increase the adhesive force between the glass and the photothermal conversion layer 28, a heat decomposable resin having within the molecule a polar group (e.g., —COOH, —OH) capable of hydrogen-bonding to the silanol group on the glass surface can be used. Furthermore, in applications requiring a chemical solution treatment such as chemical etching, in order to impart chemical resistance to the photothermal conversion layer 28, a heat decomposable resin having within the molecule a functional group capable of self-crosslinking upon heat treatment, a heat decomposable resin capable of being crosslinked by ultraviolet or visible light, or a precursor thereof (e.g., a mixture of monomers and/or oligomers) may be used. For forming the photothermal conversion layer 28 as a pressure-sensitive adhesive photothermal conversion layer, a pressure-sensitive adhesive polymer formed from poly(meth)acrylate or the like, as may be used for the heat decomposable resin, is employed.

In another embodiment, the photothermal conversion layer may include a metal or a metal/metal oxide alloy absorbing layer in place of a light absorbing agent and a heat decomposable resin. The metal absorbing layer may be formed of a single metal, a mixture of metals including two or more different metals or a metal/metal oxide alloy. Generally, any metal that absorbs light at the appropriate wavelength and converts it to heat can be used. Examples of metals which can be used include, but are not limited to: iron, aluminum, copper, nickel, gold, silver, tin, cobalt, manganese, chromium, germanium, palladium, platinum, rhodium, silicon, tungsten, zinc, titanium and tellurium. Particularly suitable metals include, but are not limited to: aluminum, gold, tin, nickel copper, zinc and chromium. Examples of metal oxide compounds that can be used to form a metal/metal oxide alloy include but are not limited to titanium oxide and aluminum oxide. An example of a suitable metal/metal oxide alloy is aluminum/aluminum oxide alloy, e.g. black alumina with an Al/Al₂O₃ weight ratio of about 25/75.

In some embodiments, the photothermal conversion layer may be in the form of a multi-layer film stack and include more than one layer. In one embodiment, a multilayer photothermal conversion layer includes at least a metal absorbing layer, a spacer layer and a metal reflecting layer. This design allows for optical tuning of the photothermal conversion layer enabling specific wavelengths of light to be reflected, transmitted and absorbed at varying levels depending on the design. Design parameters that can affect the optical tuning include the refractive index, extinction coefficient and the thickness of each layer.

### Temporary Carrier

The temporary carrier 30 is formed of a material capable of transmitting radiation energy, such as a laser beam, and capable of keeping the substrate 10 in a flat state without causing the substrate 10 to break during grinding and conveyance. The light transmittance of the temporary carrier 30 is not limited as long as it does not prevent the transmittance of a practical intensity level of radiation energy into the photothermal conversion layer 28 to enable the decomposition of the photothermal conversion layer 28 or prevent cure of the joining layer 26 if a UV or visible light curable joining layer is used. Examples of useful temporary carriers include glass plates and acrylic plates. Exemplary glass includes, but is not limited to: quartz, sapphire, and borosilicate.

The temporary carrier 30 is sometimes exposed to heat generated in the photothermal conversion layer 28 when the photothermal conversion layer 28 is irradiated or when a high temperature is produced due to frictional heating during grinding. Particularly, in the case of a silicon substrate, the temporary carrier 30 is sometimes subjected to a high-temperature process to form an oxide film. Accordingly, temporary carrier 30 having heat resistance, chemical resistance and a low expansion coefficient is selected. Examples of temporary carrier materials having these properties include borosilicate glass available as Pyrex® and Tempax® and alkaline earth boro-aluminosilicate glass such as Corning® #1737 and #7059.

### Method

FIG. 3 shows a cross-sectional view of the substrate 10 positioned within a fixture 32. The fixture 32 includes a recess 34 and a top surface 36. In the manufacture of the article 22 (shown in FIG. 2), it is important to prevent undesirable foreign substances such as air from entering between layers. For example, if air enters between layers, the thickness uniformity of the article 22 is prevented and the substrate 10 cannot be ground to a thin, uniform substrate. In one embodiment, the substrate having bonded features 16 is bonded to the temporary carrier 30 by first placing the substrate 10 within the recess 34 of the fixture 32 such that the top surfaces 20 of the bonded features 16 are positioned slightly below the top surface 36 of the fixture 32.

A bead of the leveling layer material is then placed at one edge of the fixture 32 and a coating bar such as a doctor blade or notch bar 38, is pulled across the surface of the fixture 32 to produce a leveling layer 24 that fills in the recesses 18 between the features 16, as shown in FIG. 4. As can be seen in FIG. 4, the topography of the substrate 10, as defined by the initial step height H₀ (shown in FIG. 1), is decreased to the intermediate step height H_{I} such that the recesses 18 are substantially filled in. The leveling layer 24 is then at least partially dried and/or at least partially cured. Curing can be accomplished by any means known in the art, including, but not limited to: thermal and light cure (ultraviolet light) and visible light curing. A particularly suitable means of curing is by irradiating with ultraviolet light. Although FIG. 4 depicts the leveling layer 24 as substantially filling in the recesses 18, the leveling layer 24 may only fill in the recesses 18 to a level such that the topography of the substrate 10 is reduced to between about 5% and about 95%, particularly to between about 5% and about 75% and more particularly to between 5% and about 25% of the initial step height H₀.

As shown in FIG. 5, the joining layer 26 is then deposited on top of the leveling layer 24. The amount of joining layer 26 deposited is such that the final step height H_{F} is less than about 20% of the initial step height H₀ and may be substantially planar and free of asperities or recesses. After coating, the joining layer 26 may still have some topography but it is reduced to substantially zero or zero, or 0% of the initial step height H₀, after lamination.

As mentioned earlier, in order to create a void-free bond between the substrate 10 and the temporary carrier 30, it is important that the top surface 27 of the joining layer 26 is substantially planar. For the leveling layer 24 and the joining layer 26 to fill in the recesses 18 and render the top surface 27 of the joining layer 26 uniform, the materials used for the leveling layer 24 and the joining layer 26 are preferably in a liquid state during coating and laminating and particularly has a viscosity of less than about 100,000 centipoise (cps) at the temperature (for example, 25° C.) of the coating and laminating operations. The joining layer 26 may be deposited on the leveling layer 24 by known coating techniques, including spin coating and knife coating. If a layer is spin-coated, the viscosity is less than about 5,000 cps. Generally the viscosity of the joining layer 26 is less than the viscosity of the leveling layer 24. The liquid adhesive of the joining layer 26 is preferably coated by a spin coating method among various other methods. The resulting coated substrate 10 is then bonded to the temporary carrier 30 having photothermal conversion layer 28, in a wafer support system. Pressure is applied by the flatting disc of the wafer support system bonder during a vacuum lamination step to prevent air from entering between layers. In one embodiment, the pressure is applied for between about 2 and about 120 seconds and particularly less than about 30 seconds. As such an adhesive, a UV-curable adhesive and a visible light-curable adhesive are particularly preferred, because the surface of the joining layer 26 can be made to reduce the topography of the substrate 10 to less than about 20% of the initial step height H₀, particularly less than about 5% of the initial step height H₀ and more particularly to about 0% of the initial step height H₀. Moreover, the processing speed is high for the above-mentioned reason.

After deposition of the joining layer, the photothermal conversion layer 28 and the temporary carrier 30 are attached through the leveling layer 24 and the joining layer 26. The joining layer 26 is then cured, for example, by irradiating with ultraviolet light from the side of the temporary carrier 30, whereby a laminated article can be formed.

Using this method, the leveling layer 24 and the joining layer 26 are able reduce the step height topography, facilitating a substantially void free bond.

After grinding to the desired level, the coated article 22 is removed and conveyed to subsequent steps, where the separation of the substrate 10 and the temporary carrier 30 by irradiation with a laser beam and the peeling of the leveling layer 24 and the joining layer 26 from the substrate 10 are performed. A laser beam is irradiated from the side of the temporary carrier 30 of the coated substrate 10. After the irradiation of the laser beam, the temporary carrier 30 is picked up to separate the temporary carrier 30 from the substrate 10.

After the separation of the substrate 10 and the temporary carrier 30 by the decomposition of the photothermal conversion layer 28, the substrate 10 having the leveling layer 24 and joining layer 26 thereon is obtained. Therefore, the leveling layer 24 and joining layer 26 must be easily separated from the substrate 10, such as by peeling, to obtain a thinned substrate. Thus, the leveling layer 24 and joining layer 26 have an adhesive strength high enough to fix the substrate 10 to the temporary carrier 30 yet low enough to permit separation from the substrate 10.

### EXAMPLES

The present invention is more particularly described in the following example that is intended as an illustration only, since numerous modifications and variations within the scope of the present invention will be apparent to those skilled in the art. Unless otherwise noted, all parts, percentages, and ratios reported in the following example are on a weight basis.

To create topography on a silicon wafer surface, silicon features about 8 mm×8 mm×100 microns were bonded to a 200 mm silicon wafer surface in a square array pattern having a center to center distance of 12 mm, i.e. the edges of adjacent features were about 4 mm apart. A conventional epoxy adhesive was used to bond the silicon features to the silicon wafer. After attachment, the top surfaces of the silicon features were from 120 to 150 microns above the surface of the wafer. A fixture having a 7.95 inch (202 mm) diameter by 0.040 inch (1.0 mm) deep recess was constructed from aluminum plate about 12 inch (30.5 cm)×12 inch (30.5 cm)×0.375 inch (0.953 cm) thick. The depth of the recess was about equivalent to the combined thickness of the wafer and bonded silicon features. One layer of 3M™ Greenback Printed Circuit Board Tape 852 (available from the 3M Company, St. Paul, Minn.), about 4 mil (102 micron) thick, was attached to the top of the fixture, such that the final height of the fixture upper surface was above that of the attached silicon features. The 200 mm silicon wafer with silicon features was placed in the fixture with the features facing up. To deposit the leveling layer, a bead of UV curable adhesive similar to a conventional wafer support system adhesive such as, for example, 3M™ Liquid UV-Curable Adhesive LC-4200, was placed on one edge of the fixture upper surface. A 14 inch (35.6 cm) long notch bar having a diameter of about 2 inch (5.1 cm) with a notch depth of 0.188 inch (4.78 mm) was pulled across the wafer so as to produce a leveling layer that filled in the gaps between the silicon features. The leveling layer was generally level with the top surface of the fixture surface. The leveling layer was then UV cured for 5 seconds using a 6 inch (15.2 cm) long Fusion Systems D bulb, 300 watt/inch. The leveling layer shrank somewhat during cure. The depth of the topography was reduced from a depth of about 150 microns to about 50 microns.

The resulting coated wafer was bonded to a 201 mm diameter×0.7 mm thick glass carrier using a wafer support system bonder, model number WSS 8101M (available from Tazmo Co., LTD. Freemont, Calif.). The glass carrier included a photothermal conversion layer, JS-5000-0012-5 (available from Sumitomo 3M Ltd., Tokyo, Japan), less than 1 micron thick. A second adhesive was used as the joining layer material to bond the carrier to the previously coated and cured silicon wafer. The composition of joining layer was as follows: 50 parts (by weight) of a diacrylate oligomer (BAC-45, available from Osaka Organic Chemical Co., Ltd., Tokyo, Japan), 30 parts tricyclodecane dimethanol diacrylate (SR833S, available from Sartomer Corp., Exton, Pa.), 20 parts phenoxyethyl acrylate (prepared internally at 3M), 2 parts diacrylate oligomer (Ebecryl 350, available from Cytec Industries, Woodland Park, N.J.), and 1 part photoinitiator (Irgacure 819, available from CIBA, Basel Switzerland). During the bonding process, the photothermal conversion layer of the carrier was facing the topographical surface of the silicon wafer with features and the joining layer was located between the two. Pressure was applied by the apparatus flatting disc for 7 seconds during the vacuum lamination step. The joining layer was cured using the previously described UV bulb, where the cure time was 25 seconds. The joining layer was able to fill in the remaining 50 microns of topography resulting in a void free bond between the carrier and silicon wafer.

After bonding to the carrier, the laminated wafer and carrier were laser rastered in a wafer support system demounter, model number WSS 8101D (available from Tazmo Co., LTD. Freemont Calif.) using Powerline E Series laser (available from Rofin-Sinar Technologies, Inc., Stuttgart, Germany). Rastering was conducted at a power of 38 watt, at a raster speed of 2000 mm/s, with a raster pitch of 200 microns. The photothermal conversion layer was decomposed and the carrier was removed from the silicon wafer with silicon features.

Although the present invention has been described with reference to preferred embodiments, workers skilled in the art will recognize that changes may be made in form and detail without departing from the spirit and scope of the invention.

What is claimed is:

1. An article useful for wafer processing comprising:
a substrate having a first major surface, a second major surface and at least one three dimensional topographical feature extending from the first major surface, the topographical feature having an initial step height;
a leveling layer positioned adjacent to the first major surface for reducing a topography of the substrate to between about 5% and about 95% of the initial step height;
a joining layer positioned adjacent to the leveling layer for further reducing the topography of the substrate to less than about 20% of the initial step height;
a photothermal conversion layer positioned adjacent to the joining layer; and
a temporary carrier positioned adjacent the photothermal conversion layer.

2. The article of claim 1, wherein the joining layer reflects light in the near infrared region.

3. The article of claim 1, wherein the leveling and joining layers are temporarily attached to the substrate.

4. The article of claim 1, wherein the leveling layer reduces the topography of the substrate to between about 5% and about 75% of the initial step height.

5. The article of claim 1, wherein the joining layer reduces the topography of the substrate to less than about 5% of the initial step height.

6. The article of claim 5, wherein the joining layer reduces the topography of the substrate to about 0% of the initial step height.

7. The article of claim 1, wherein the temporary carrier is light transmitting.

8. The article of claim 1, wherein the feature height is at least about 50 microns.

9. The article of claim 1, wherein the joining layer has a thickness of between about 10 and about 150 microns.

10. A method of manufacturing a laminated article, the method comprising:
providing a substrate having first and second major surfaces, wherein at least the first major surface includes a three dimensional topographical feature covering at least a portion of its surface, the topographical feature having an initial step height;
coating a leveling layer on the first major surface to reduce a topography of the substrate to between about 5% and about 95% of the initial step height;
coating a joining layer onto the leveling layer to further reduce the topography of the substrate to less than about 20% of the initial step height;
providing a temporary carrier;
providing a photothermal conversion layer;
joining the substrate to the temporary carrier by contacting the joining layer to the photothermal conversion layer and the photothermal conversion layer to the temporary carrier; and
drying or curing the photothermal conversion layer, joining layer and leveling layer to form the laminated article.

11. The method of claim 10, wherein the leveling layer is at least partially dried and/or partially cured prior to coating the joining layer.

12. The method of claim 10, wherein the joining layer is at least partially dried and/or partially cured prior to providing the photothermal conversion layer.

13. The method of claim 10, wherein the leveling layer is coated onto the first major surface of the substrate using a doctor blade or a notch bar.

14. The method of claim 10, wherein the joining layer is coated onto the leveling layer by spin coating.

15. The method of claim 10, wherein the leveling layer reduces the topography of the substrate to between about 5% and about 75% of the initial step height

16. The method of claim 10, wherein the joining layer reduces the topography of the substrate to about 0% of the initial step height.

17. The method of claim 15, wherein the providing the photothermal conversion layer comprises coating the photothermal conversion layer onto one of the joining layer and the temporary carrier.
